(19) United States
(12) Patent Application Publication
(10) Pub. No.: US 2017/0048008 A1
(43) Pub. Date: Feb. 16, 2017

(54) METHOD AND APPARATUS FOR VERIFICATION OF NETWORK SERVICE IN NETWORK FUNCTION VIRTUALIZATION ENVIRONMENT

(71) Applicant: ELECTRONICS AND TELECOMMUNICATIONS RESEARCH INSTITUTE, Daejeon (KR)

(72) Inventor: Jong-Hwa YI, Daejeon (KR)

(21) Appl. No.: 14/933,206

(22) Filed: Nov. 5, 2015

(30) Foreign Application Priority Data
Aug. 11, 2015 (KR) 10-2015-0113277

(51) Int. Cl. H04B 17/17; H04B 17/382; H04B 17/309

(52) U.S. Cl. CPC H04B 17/17; H04B 17/309; H04B 17/382

(57) ABSTRACT

Disclosed herein are a method and apparatus for verification of a network service in a network function virtualization (NFV) environment. The method includes performing verification of at least one of a function, operation, and performance related to a network service, and transmitting results of the verification to an entity related to the network service. A verification apparatus detects, either in advance or at runtime, malfunctions that may occur when a network service is executed in an NFV environment, and performs verification of at least one of the function, operation, and performance related to a network service.

### CROSS REFERENCE TO RELATED APPLICATION

This application claims the benefit of Korean Patent Application No. 10-2015-0113277, filed Aug. 11, 2015, which is hereby incorporated by reference in its entirety into this application.

### BACKGROUND OF THE INVENTION

1. Technical Field

The following embodiments generally relate to network services and, more particularly, to a method and apparatus for verification of a network service in a network function virtualization environment.

2. Description of the Related Art

Network Function Virtualization (NFV) is a network architecture concept, and proposes virtualization-related technologies for virtualizing entire classes of network node functions into connected (or chained) blocks in order to construct a communication service.

Frameworks for supporting NFV have been set forth by the European Telecommunications Standards Institute (ETSI) and the like.

In an NFV environment, each network service describes information about a Virtual Network Function (VNF) to be used thereby, a VNF forwarding graph, dependencies between VNFs, an auto-scaling policy, Quality of Service (QoS), monitoring parameters, etc. in a descriptor. The forwarding graph denotes the sequence in which VNFs are connected.

In accordance with the descriptor of the network service, an NFV system may configure a network service and may allocate resources required to execute the network service.

As described above, a network service may indicate a list of VNFs to be used thereby and dependencies between VNFs, and may describe information about a forwarding graph, which defines the sequence of execution of VNFs. Such an NFV system needs to verify whether all of the requirements of the network service are satisfied and whether errors occurred during the course of satisfying the requirements, before the service is executed or while the service is being executed. By means of the verification by the NFV system, the security of the NFV system may be enhanced.

In relation to an NFV system, Korean Patent Application Publication No. 10-2011-0079102 and U.S. Patent Application Publication No. 2014-0201374 were disclosed.

### SUMMARY OF THE INVENTION

An embodiment is intended to provide a method and apparatus that verify a network service.

Another embodiment is intended to provide a method and apparatus that check errors in the configuration of a network service and errors in the execution of the network service.

A further embodiment is intended to provide a method and apparatus that define a structure, an interface, and a scheme for verifying a network service.

In accordance with an aspect of the present disclosure, there is provided a method for verification of a network service in a Network Function Virtualization (NFV) environment, the method performing verification of NFV, the method including performing verification of at least one of a function, operation, and performance related to a network service; and transmitting results of the verification to an entity related to the network service.

The method may further include receiving a request for the verification from an NFV orchestrator of an NFV Management and Orchestration (MANO) unit.

The results of the verification may be transmitted to the NFV orchestrator.

The request may be made for each unit of verification.

The unit of verification may include at least one of a network service, a Virtual Network Function (VNF), and a VNF forwarding graph.

When the unit of verification is the VNF forwarding graph, the verification of the VNF forwarding graph may include determining whether all instances of at least one VNF in the VNF forwarding graph are present.

When the unit of verification is the VNF forwarding graph, the verification of the VNF forwarding graph may include determining whether the VNF forwarding graph has been generated to satisfy VNF dependency requirements.

When the unit of verification is the VNF forwarding graph, the verification of the VNF forwarding graph may include checking whether an error is present in a network of the VNF forwarding graph.

The verification of the VNF forwarding graph may be performed when a forwarding path of at least one VNF in the VNF forwarding graph is generated using information about a physical location where the at least one VNF is actually present.

The method may further include receiving a call for the verification from an application that is to request execution of the network service before execution of the network service is requested.

The results of the verification may be transmitted to the application.

The verification may be performed by a verification module of a NFV functional block.

The entity related to the network service may be an application.

The method may further include receiving information required for verification, provided by an NFV orchestrator, from the application.

The information required for verification may include information about VNF catalogs and records.

The information required for verification may include VNF information about a VNF required for the network service.

The information required for verification may include information about resources requested to be allocated for the network service.

Performing the verification may include selecting a mode of the verification; acquiring information required for verification; and inspecting the network service using the acquired information.

The information required for verification may include information about VNF catalogs and records.

The VNF catalog and record information may be acquired from an NFV orchestrator of an NFV MANO unit.

The information required for verification may include VNF information about a VNF required for the network service.

The VNF information may be acquired from a VNF manager.

The information required for verification may include information about resources requested to be allocated for the network service.

The resource information may be acquired from a virtual infrastructure manager.

Inspecting the network service may include generating information represented in a modeling language by converting the information required for verification into information in the modeling language; generating a state transition graph using the information represented in the modeling language; and performing the verification by determining whether an error is present in the state transition graph.

The modeling language may be a packet-based Algebra of Communicating Shared Resources (pACSR) modeling language.

In accordance with another aspect of the present disclosure, there is provided a method for verification of a network service in a Network Function Virtualization (NFV) environment, including receiving a request to execute a network service from an application; transmitting a call for verification related to the network service to a verification module before executing the network service; receiving results of the verification related to the network service from the verification module; and checking whether a fault is present in at least one of a function, operation, and performance of the network service, using the results of the verification.

In accordance with a further aspect of the present disclosure, there is provided an apparatus for verification, the apparatus performing verification of NFV, including memory for storing at least one program; and a processor for executing the at least one program, wherein the at least one program may include a verification module, and wherein the verification module performs verification of at least one of a function, operation, and performance related to the network service, and transmits results of the verification to an entity related to the network service.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram showing the functional block of NFV according to an embodiment;

FIG. 2 illustrates a formal verification apparatus according to an embodiment;

FIG. 3 is a flowchart showing a formal verification method according to an embodiment;

FIG. 4 illustrates a formal verification method based on the request of an application according to an embodiment;

FIG. 5 illustrates a formal verification method based on the request of an NFV orchestrator;

FIG. 6 is a flowchart showing a formal verification method according to an embodiment;

FIG. 7 is a flowchart showing a formal verification method for a VNF forwarding graph according to an embodiment; and

FIG. 8 illustrates a formal verification method based on the request of an application and the provision of information by the application according to an embodiment.

### DESCRIPTION OF THE PREFERRED EMBODIMENTS

The following detailed descriptions of the present invention will be made with reference to the attached drawings that illustrate specific embodiments in which the present invention can be practiced. These embodiments will be described in detail so that those skilled in the art can sufficiently practice the present invention. It should be understood that various embodiments of the present invention may differ, but they do not need to be exclusive. For example, specific shapes, structures and characteristics described herein in an embodiment may be implemented in various manners in other embodiments without departing from the spirit and scope of the present invention. Further, it should be understood that the locations and arrangements of individual elements in each disclosed embodiment may be changed without departing from the spirit and scope of the present invention. Therefore, the following detailed descriptions are not intended to limit the present disclosure, and the scope of the present invention should be limited only by the accompanying claims along with all equivalent scopes of the claims as long as it is suitably described. The same or similar reference numerals are used to designate the same or similar elements or functions throughout the drawings.

Hereinafter, exemplary embodiments of the present invention will be described in detail with reference to the attached drawings so that those skilled in the art to which the present invention pertains can easily practice the present invention.

Hereinafter, for the exemplary embodiments of the present invention, a term “formal verification” may be replaced with a term “verification”.

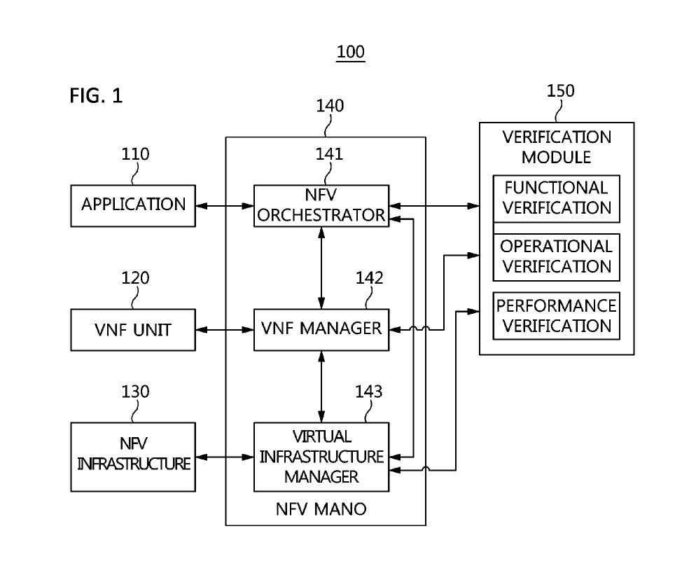

FIG. 1 is a configuration diagram showing a functional block of NFV according to an embodiment.

An NFV functional block 100 shown in FIG. 1 may include basic functional blocks and interfaces that support NFV defined by the ETSI. Further, the NFV functional block 100 may include a verification module and an interface for the verification module.

The NFV functional block 100 for an NFV system may include an application 110, a Virtual Network Function (VNF) unit 120, an NFV infrastructure 130, an NFV Management and Orchestration (MANO) unit 140, and a verification module 150.

The application 110 may use a network service. In order for the application 110 to use the network service, the verification of the function, operation, and performance related to the network service may be required.

The application 110 may be an application used by a network or an operator in relation to the operation of the network. For example, the application 110 may be a Business Support Systems (BSS) application or an Operations Support Systems (OSS) application.

The VNF unit 120 may be a software implementation of network functions. The VNF unit 120 may include multiple VNFs. The multiple VNFs may be respectively implemented by multiple physical devices.

The NFV infrastructure 130 may be the totality of hardware and software components that build up the environment in which VNFs are deployed.

The NFV MANO unit 140 may be the collection of all functional blocks and data repositories used by the functional blocks.

The NFV MANO unit 140 may include an NFV orchestrator 141, a VNF manager 142, and a virtual infrastructure manager 143. The NFV orchestrator 141, the VNF manager 142, and the virtual infrastructure manager 143 may communicate with each other.

The NFV orchestrator 141 may be on-boarding of new network services, VNF forwarding graphs, and VNF packages. The NFV orchestrator 141 may perform various functions, such as the lifecycle management of a network service, global resource management, validation, and authorization of NFV infrastructure resource requests. The lifecycle management of a network service may include instantiation, scale-out, scale-in, performance measurement, event correlation, and termination. The NFV orchestrator 141 may perform the policy management of network service instances.

The VNF manager 142 may perform the lifecycle management of VNF instances.

The virtual infrastructure manager 143 may perform the calculation of NFV infrastructure in the infrastructure sub-domain of a single operator, and the control and management of storage and network resources.

The NFV orchestrator 141 may receive a request to execute a network service from the application 110.

The NFV orchestrator 141 may transmit a request to use a VNF required for the network service to the VNF manager 142. The VNF manager 142 allows the network service to use the VNF indicated by the VNF use request. The VNF manager 142 may transmit a response to the VNF use request to the NFV orchestrator 141.

Further, the NFV orchestrator 141 may transmit a request to allocate resources required for the network service to the virtual infrastructure manager 143. The virtual infrastructure manager 143 may allocate the resources to the network service. The virtual infrastructure manager 143 may transmit a response to the resource allocation request to the NFV orchestrator 141.

To perform the above-described functions, the NFV orchestrator 141, the VNF manager 142, and the virtual infrastructure manager 143 may communicate with the application 110, the VNF unit 120, and the NFV infrastructure 130, respectively.

The verification module 150 may perform verification related to the network service provided to the application 110.

The verification module 150 may check whether there are errors in the configuration of the network service or whether errors occur during the course of execution of the network service. An interface and a scheme for verification may be defined in the verification module 150.

The verification module 150 may perform verification related to at least one of the function, operation, and performance of the network service. The verification module 150 may provide functions required for functional verification, operational verification, and performance verification related to the network service. Also, the verification module 150 may perform verification depending on the characteristics and request of the network service, and may provide notification of the results of the verification.

To verify at least one of the function, operation, and performance of the network service, the verification module 150 may communicate with each of the NFV orchestrator 141, the VNF manager 142, and the virtual infrastructure manager 143. The verification module 150 may include respective interfaces with the NFV orchestrator 141, the VNF manager 142, and the virtual infrastructure manager 143.

The verification module 150 may detect errors which may be present in the configuration of the network service or errors which may occur during the operation of the network service by using the network service descriptor in the NFV environment, and may provide notification of any detected errors. The verification module 150 may use a formal method to detect and provide notification of errors, and may utilize a packet-based Algebra of Communicating Shared Resources (pACSR) modeling language.

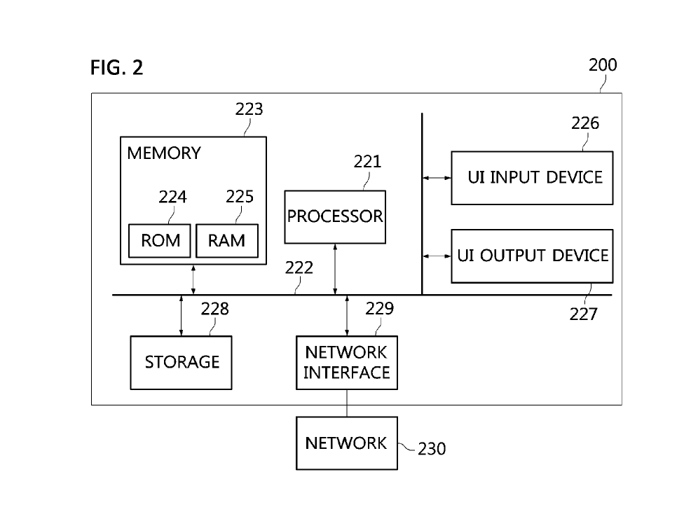

FIG. 2 illustrates a formal verification apparatus according to an embodiment.

A formal verification apparatus 200 may be implemented in a computer system including a computer-readable storage medium. As shown in FIG. 2, the formal verification apparatus 200 may include a processor 221, memory 223, a User Interface (UI) input device 226, a UI output device 227, and storage 228, which communicate with each other via a bus 222. The formal verification apparatus 200 may further include a network interface 229 connected to a network 230. The processor 221 may be a Central Processing Unit (CPU) or a semiconductor device for executing the processing instructions stored in the memory 223 or the storage 228. Each of the memory 223 and the storage 228 may be any of various types of volatile or non-volatile storage media. For example, the memory 223 may include Read Only Memory (ROM) 224 or Random Access Memory (RAM) 225.

The memory 223 may store at least one program, and the processor 221 may execute at least one program. Functions related to the communication of data or information from the formal verification apparatus 200 may be performed by the network interface 229.

At least one program may include, but is not limited to, a routine, a subroutine, a program, an object, a component, and a data structure for performing specific operations, which will be described later, or for executing specific abstract data types. The at least one program may be implemented using instructions or code executed by the processor 221.

The at least one program may include the verification module 150. The at least one program may further include at least one of the application 110, the VNF unit 120, the NFV infrastructure 130, and the NFV MANO unit 140.

Alternatively, each of the application 110, the VNF unit 120, the NFV infrastructure 130, and the NFV MANO unit 140 may be an independent device other than the formal verification apparatus 200. Further, each of the application 110, the VNF unit 120, the NFV infrastructure 130, and the NFV MANO unit 140 may be executed in an independent device other than the formal verification apparatus 200. In other words, the application 110, the VNF unit 120, the NFV infrastructure 130, the NFV MANO unit 140, and the verification module 150 may be distributed to and implemented in multiple physical devices.

At least some of the application 110, the VNF unit 120, the NFV infrastructure 130, the NFV MANO unit 140, and the verification module 150 may communicate with an external device or system. The VNF unit 120, the NFV infrastructure 130, the NFV MANO unit 140, and the verification module 150 may be included in the formal verification apparatus 200 in the form of operating systems, applications, and other programs, and may be physically stored in various well-known storage devices. Also, at least some of the application 110, the VNF unit 120, the NFV infrastructure 130, the NFV MANO unit 140, and the verification module 150 may be stored in a remote storage device capable of communicating with the formal verification apparatus 200.

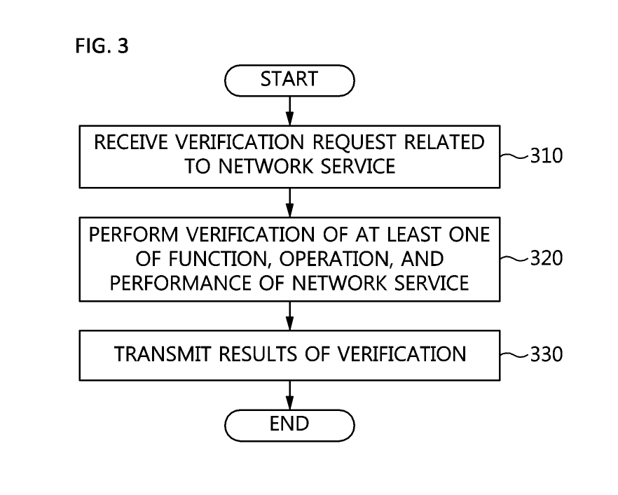

FIG. 3 is a flowchart showing a formal verification method according to an embodiment.

By means of the following steps, the verification module 150 may verify NFV. The verification module 150 may perform formal verification related to a network service in an NFV environment.

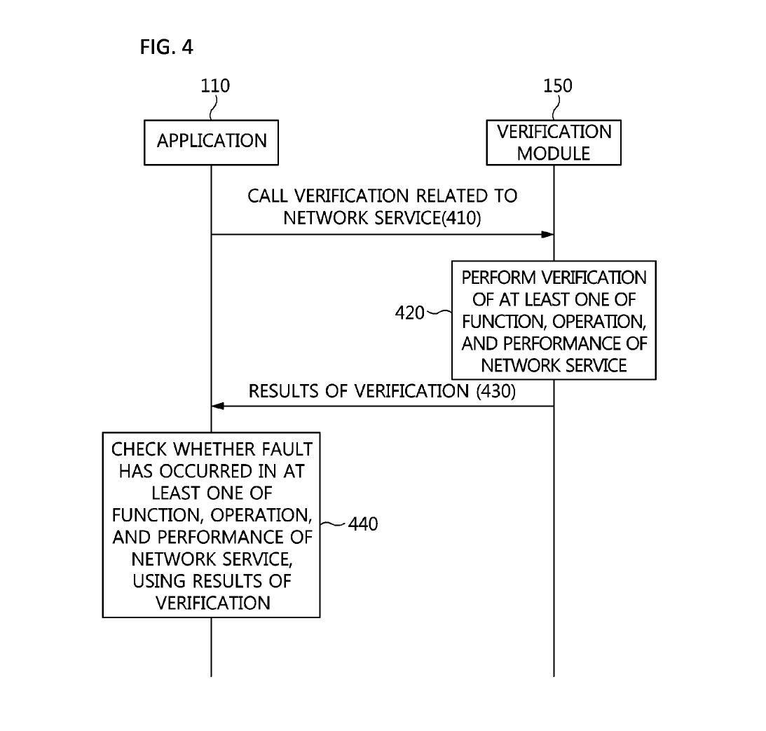

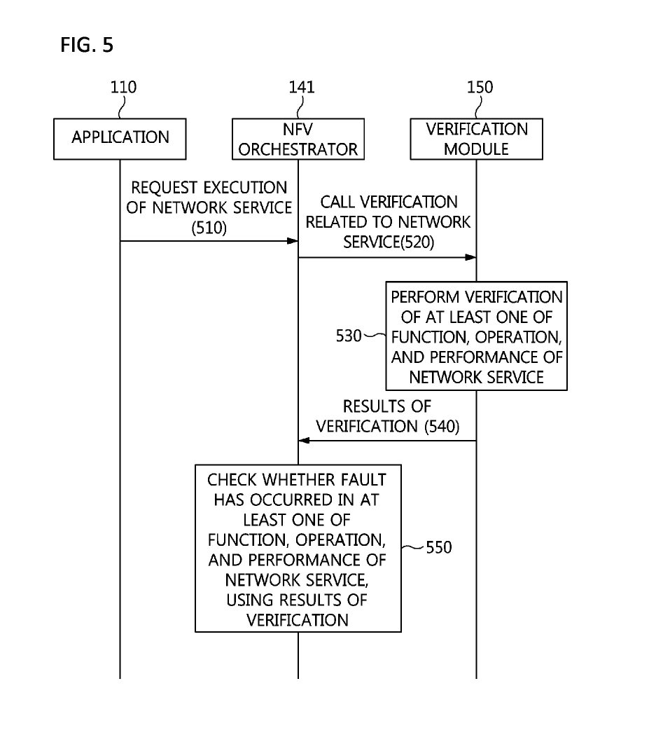

At step 310, the verification module 150 may receive a request for verification related to a network service from an entity related to the network service. The entity related to the network service may be the application 110 or the NFV orchestrator 141. The case where verification related to the network service is requested by the application 110 will be described later with reference to FIG. 4. The case where verification related to the network service is requested by the NFV orchestrator 141 will be described later with reference to FIG. 5.

The request for verification may be made for each unit of verification. In other words, the verification request may represent the unit of verification.

The unit of verification may include at least one of a network service, a VNF, and a VNF forwarding graph. In other words, the verification module 150 may perform the verification of the network service, the VNF or the VNF forwarding graph.

At step 320, the verification module 150 may verify the network service. The verification module 150 may perform the verification of at least one of the function, operation, and performance of the network service.

The verification module 150 may check whether there are errors in the configuration of the network service or whether errors occur during the course of execution of the network service.

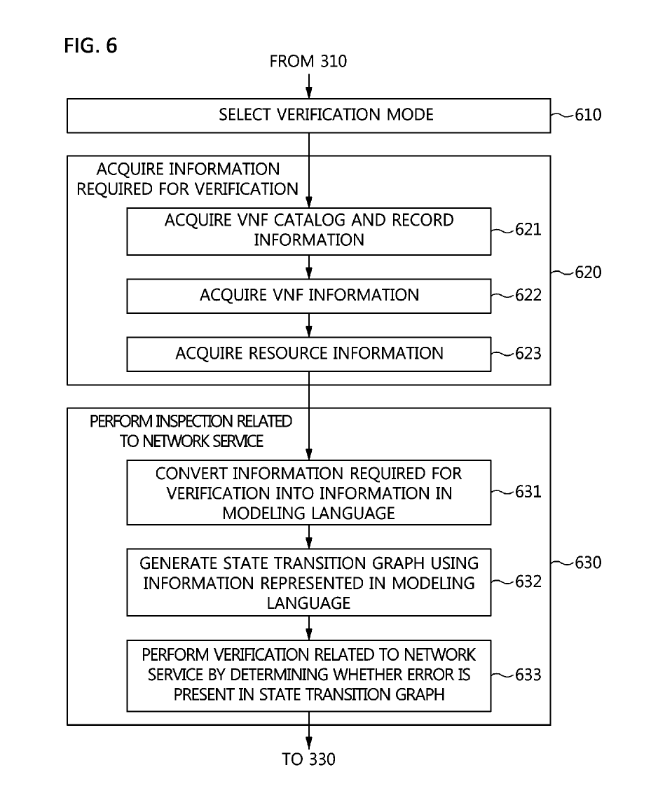

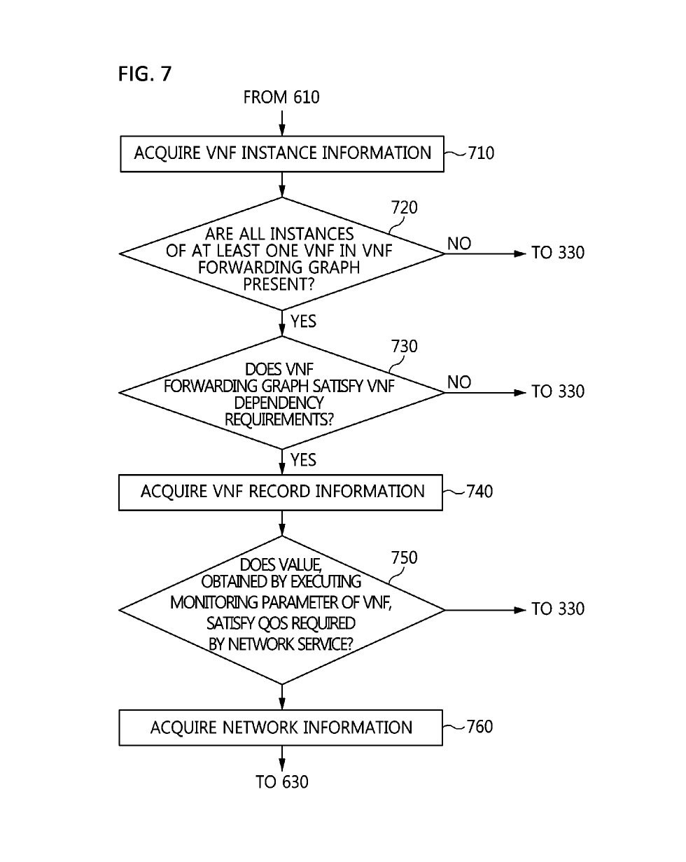

Verification related to the network service will be described in detail later with reference to FIGS. 6 and 7.

At step 330, the verification module 150 may transmit the results of the verification to the entity related to the network service (network service-related entity) that requested the verification.

The reception of the verification request at step 310 and the transmission of the verification results at step 330 may be performed by the interface handler of the verification module 150.

FIG. 4 illustrates a formal verification method based on the request of an application according to an embodiment.

The application 110 may perform verification related to a network service desired to be used by the application by directly calling the verification module 150 before requesting the network service from an NFV system. In other words, before the network service desired to be used by the application 110 is executed on the NFV system, the application may perform verification related to the network service by directly calling the verification module 150.

At step 410, the application 110 may transmit a call for verification related to the network service to the verification module 150. Before the execution of the network service is requested by the application 110, the verification module 150 may receive the call for verification related to the network service from the application that will request the execution of the network service.

At step 420, the verification module 150 may perform verification of at least one of the function, operation, and performance of the network service.

At step 430, the results of the verification may be transmitted by the verification module 150 to the application 110. The verification module 150 may transmit the results of the verification related to the network service to the application 110. The application 110 may receive the results of the verification related to the network service from the verification module 150.

At step 440, the application 110 may check whether a fault has occurred in at least one of the function, operation, and performance of the network service, using the results of the verification related to the network service.

Step 410, step 420, and step 430 may correspond respectively to steps 310, 320, and 330, which have been described above with reference to FIG. 3.

FIG. 5 illustrates a formal verification method based on the request of the NFV orchestrator according to an embodiment.

At step 510, the application 110 may transmit a request to execute a network service desired to be used by the application to the NFV orchestrator 141. The NFV orchestrator 141 may receive the execution request for the network service from the application 110.

The execution request may include a Network Service Chaining (NSC) descriptor.

In response to the execution request for the network service, the NFV orchestrator 141 may request verification related to the network service before executing the network service. By means of verification related to the network service, the NFV orchestrator 141 may determine whether there is a possibility that an error will occur due to the execution of the network service before executing the network service.

At step 520, the NFV orchestrator 141 may transmit a call for verification related to the network service to the verification module 150. Before the network service is executed by the NFV orchestrator 141, the verification module 150 may receive a request for verification related to the network service from the NFV orchestrator 141.

The verification call may be made for each unit of verification. For example, the NFV orchestrator 141 may select the unit of verification, and may transmit a request for verification corresponding to the selected unit of verification to the verification module 150.

At step 530, the verification module 150 may perform the verification of at least one of the function, operation, and performance of the network service.

At step 540, the results of the verification may be transmitted by the verification module 150 to the NFV orchestrator 141. The verification module 150 may transmit the results of the verification related to the network service to the NFV orchestrator 141. The NFV orchestrator 141 may receive the results of the verification related to the network service from the verification module 150.

At step 550, the NFV orchestrator 141 may check whether a fault has occurred in at least one of the function, operation, and performance of the network service, using the results of the verification related to the network service.

Further, the NFV orchestrator 141 may determine, using the results of the verification related to the network service, whether to execute the network service.

Steps 520, 530, and 540 may correspond respectively to steps 310, 320, and 330, which have been described above with reference to FIG. 3.

FIG. 6 is a flowchart showing a formal verification method according to an embodiment.

In a method for performing formal verification of a network service in an NFV environment, step 320, described above with reference to FIG. 3, may include the following steps 610, 620, and 630. Before step 610, step 310 may be performed, and after step 630, step 330 may be performed.

At step 610, the verification module 150 may select the type (mode) of verification.

At step 620, the verification module 150 may acquire information required for verification.

The information required for verification may include information about the execution conditions of the network service.

Step 620 may include steps 621, 622, and 623.

The information required for verification may include information about VNF catalogs and records.

At step 621, the verification module 150 may acquire the VNF catalog and record information from the NFV orchestrator 141.

The information required for verification may include VNF information about VNFs required for the network service.

At step 622, the verification module 150 may acquire the VNF information from the VNF manager 142.

The information required for verification may include resource information about resources requested to be allocated for the network service.

At step 623, the verification module 150 may acquire the resource information from the virtual infrastructure manager 143.

At step 630, the verification module 150 may perform inspection related to the network service using the acquired information.

Step 630 may include steps 631, 632, and 633.

At step 631, the verification module 150 may generate information represented in a modeling language by converting the information required for verification into information in the modeling language.

The modeling language may be a packet-based Algebra of Communicating Shared Resources (pACSR) modeling language.

At step 632, the verification module 150 may generate a state transition graph using the information represented in the modeling language.

At step 633, the verification module 150 may perform verification related to the network service by determining whether an error is present in the state transition graph.

If it is determined that an error is present in the state transition graph, the verification module 150 may provide results indicating the verification error. For example, at step 330, described above with reference to FIG. 3, the verification module 150 may transmit the results indicating the verification error to the network service-related entity that requested the verification. If it is determined that no error is present in the state transition graph, the verification module 150 may provide results indicating that verification was successful. For example, at step 330, described with reference to FIG. 3, the verification module 150 may transmit the results indicating successful verification to the network service-related entity that requested the verification.

FIG. 7 is a flowchart showing a formal verification method for a VNF forwarding graph according to an embodiment.

In an NFV environment, when the network service uses various VNFs, the network service may include a VNF forwarding graph. The VNF forwarding graph may indicate the sequence of execution of various VNFs. When the network service includes the VNF forwarding graph, the unit of verification may be a VNF forwarding graph. The verification module 150 may verify whether there is a possibility that an error will occur upon performing verification based on the VNF forwarding graph.

When the unit of verification is the VNF forwarding graph, step 620, described above with reference to FIG. 6, may include the following steps 710, 720, 730, 740, 750, and 760. Before step 710, step 610 may be performed. After step 760, step 630 may be performed.

Further, at step 620, in addition to acquiring information required for verification, the verification module 150 may perform verification using the information acquired in relation to the VNF forwarding graph. For example, at step 620, the verification module 150 may perform verification, without requiring conversion into information in a pACSR modeling language or the use of the state transition graph.

At step 710, the verification module 150 may acquire information about VNF instances from the NFV orchestrator 141.

At step 720, the verification module 150 may determine, using the VNF instance information, whether all instances of at least one VNF in the VNF forwarding graph are present.

In other words, when the unit of verification is a VNF forwarding graph, the verification of the VNF forwarding graph may include a procedure in which the verification module 150 determines whether all instances of at least one VNF in the VNF forwarding graph are present.

If all instances of the at least one VNF in the VNF forwarding graph are not present, the verification module 150 may determine that the verification error has occurred. In this case, at step 330, described above with reference to FIG. 3, the verification module 150 may provide the results of the verification error indicating that the instances of the VNF are not present.

If all instances of the at least one VNF in the VNF forwarding graph are present, the verification module 150 may continue to verify the VNF forwarding graph.

At step 730, the verification module 150 may determine, using the VNF instance information, whether the VNF forwarding graph satisfies VNF dependency requirements.

In other words, when the unit of verification is the VNF forwarding graph, the verification of the VNF forwarding graph may include a procedure in which the verification module 150 determines whether the VNF forwarding graph has been generated to satisfy the VNF dependency requirements.

If the VNF forwarding graph does not satisfy the VNF dependency requirements, the verification module 150 may determine that the verification error has occurred. In this case, at step 330, described above with reference to FIG. 3, the verification module 150 may provide the results of the verification error indicating that an error is present in VNF dependency.

In contrast, if the VNF forwarding graph satisfies the VNF dependency requirements, the verification module 150 may continue to verify the VNF forwarding graph.

At step 740, the verification module 150 may acquire information about VNF records from the VNF manager 142.

At step 750, the verification module 150 may determine whether a value, obtained by executing a monitoring parameter of at least one VNF in the VNF forwarding graph, satisfies the Quality of Service (QoS) required by the network service.

If the value, obtained by executing the monitoring parameter of the at least one VNF in the VNF forwarding graph, does not satisfy the QoS required by the network service, the verification module 150 may determine that the verification error has occurred. In this case, at step 330, described above with reference to FIG. 3, the verification module 150 may provide the results of the verification error indicating that the error in QoS is present.

If the value, obtained by executing the monitoring parameter of the at least one VNF in the VNF forwarding graph, satisfies the QoS required by the network service, the verification module 150 may continue to verify the VNF forwarding graph.

At step 760, the verification module 150 may acquire network information from the virtual infrastructure manager 143.

After the network information has been acquired, step 630 described above with reference to FIG. 6 may be performed. When the unit of verification is a VNF forwarding graph, the verification module 150 may perform verification of the VNF forwarding graph. At step 633, when a forwarding path of at least one VNF in the VNF forwarding graph is generated using information about a physical location where the at least one VNF is actually present, the verification module 150 may verify the VNF forwarding graph. The verification of the VNF forwarding graph may include a procedure for determining whether an error is present in the network of the VNF forwarding graph. For example, the error in the network may be a loop. At step 330, if there is a loop in the network, the verification module 150 may provide the results of the verification error indicating that an error is present in the network of the VNF forwarding graph.

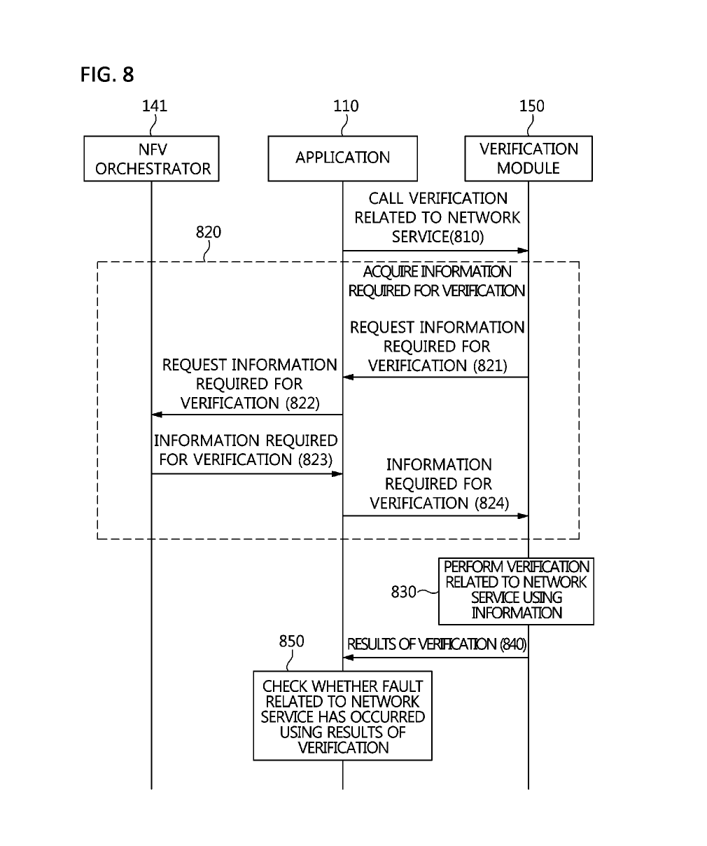

FIG. 8 illustrates a formal verification method based on the request of an application and the provision of information by the application according to an embodiment.

At step 810, the application 110 may transmit a call for verification related to a network service desired to be used by the application to the verification module 150. For example, the application 110 may perform verification related to the network service via the verification module 150 before requesting the network service from the NFV orchestrator 141.

The verification module 150 may receive a request for verification related to the network service from the application 110.

The call for verification may be made for each unit of verification. For example, the application 110 may select the unit of verification, and may transmit a request for verification corresponding to the selected unit of verification to the verification module 150.

At step 820, the verification module 150 may acquire information required for verification.

At step 820, the verification module 150 may receive information required for verification, provided by the NFV orchestrator 141, from the application 110.

Step 820 may include steps 821, 822, 823, and 824.

At step 821, the verification module 150 may transmit a request for information required for verification to the application 110. The application 110 may receive the request for information required for verification from the verification module 150.

As described above with reference to FIG. 6, the information required for verification may include information about the execution conditions of the network service. The information required for verification may include information about VNF catalogs and records. The information required for verification may include VNF information about VNFs required for the network service. The information required for verification may include resource information about resources requested to be allocated for the network service.

At step 822, the application 110 may transmit a request for information required for verification to the NFV orchestrator 141. The NFV orchestrator 141 may receive the request for information required for verification from the application 110.

At step 823, when the request for information required for verification is received, the NFV orchestrator 141 may transmit the information required for verification to the application 110. The application 110 may receive the information required for verification from the NFV orchestrator 141.

For example, the NFV orchestrator 141 may transmit at least one of 1) VNF catalog and record information, 2) VNF information, and 3) resource information as the information required for verification, to the application 110.

At step 824, when the information required for verification is provided from the NFV orchestrator 141, the application 110 may transmit the information required for verification to the verification module 150. The verification module 150 may receive the information required for verification from the application 110.

At step 830, the verification module 150 may perform inspection related to the network service using the information required for verification.

The verification module 150 may perform verification of at least one of the function, operation, and performance of the network service requested to be verified using the acquired information required for verification.

For example, the verification module 150 may generate information represented in a modeling language by converting the information required for verification into information in the modeling language. The modeling language may be a pACSR modeling language.

Further, the verification module 150 may generate a state transition graph using the information represented in the modeling language. The verification module 150 may perform verification related to the network service by determining whether an error is present in the state transition graph.

If it is determined that an error is present in the state transition graph, the verification module 150 may provide results indicating a verification error. For example, the verification module 150 may transmit the results indicating the verification error to the network service-related entity that requested the verification. In contrast, if it is determined that no error is present in the state transition graph, the verification module 150 may provide results indicating that verification was successful. For example, the verification module 150 may transmit the results indicating successful verification to the network service-related entity that requested the verification.

At step 840, the results of the verification may be transmitted by the verification module 150 to the application 110. The verification module 150 may transmit the results of the verification related to the network service to the application 110. The application 110 may receive the results of the verification related to the network service from the verification module 150.

At step 850, the application 110 may check whether a fault related to the network service has occurred, using the results of the verification provided from the verification module 150.

The application 110 may check whether a fault has occurred in at least one of the function, operation, and performance of the network service, using the results of the verification related to the network service.

Steps 810, 820, 821, 822, 823, 824, 830, 840, and 850, described above with reference to FIG. 8 may correspond to those in another embodiment or another example.

For example, step 810 may correspond to step 410, described above with reference to FIG. 4, and step 830 may correspond to step 420, described above with reference to FIG. 4. Further, step 840 may correspond to step 430, described above with reference to FIG. 4, and step 850 may correspond to step 440, described above with reference to FIG. 4.

For example, step 810 may correspond to step 310, described above with reference to FIG. 3. Step 830 may correspond to step 320, described above with reference to FIG. 3. Step 840 may correspond to step 330, described above with reference to FIG. 3.

At step 330, the network service-related entity that requested the verification may be the application 110.

Step 830 may include steps 610, 620, and 630, described above with reference to FIG. 6.

The method according to the embodiment may be implemented as a program that can be executed by various computer means. In this case, the program may be recorded on a computer-readable storage medium. The computer-readable storage medium may include program instructions, data files, and data structures solely or in combination. Program instructions recorded on the storage medium may have been specially designed and configured for the present disclosure, or may be known to or available to those who have ordinary knowledge in the field of computer software. Examples of the computer-readable storage medium include all types of hardware devices specially configured to record and execute program instructions, such as magnetic media, such as a hard disk, a floppy disk, and magnetic tape, optical media, such as compact disk (CD)-read only memory (ROM) and a digital versatile disk (DVD), magneto-optical media, such as a floptical disk, ROM, random access memory (RAM), and flash memory. Examples of the program instructions include machine language code, such as code created by a compiler, and high-level language code executable by a computer using an interpreter. The hardware devices may be configured to operate as one or more software modules in order to perform the operation of the present disclosure, and vice versa.

As described above, a method and apparatus for verification of a network service are provided.

Further, there are provided a method and apparatus that can detect, either in advance or at runtime, malfunctions that may occur when a network service is executed in an NFV environment.

Furthermore, there are provided a method and apparatus that can detect, either in advance or at runtime, malfunctions that may occur when a network service is executed over an NFV network in the case where VNFs are implemented in various types of network equipment.

Furthermore, there are provided a method and apparatus that can perform verification of network services implemented by external third-party developers.

As described above, although the embodiments have been described with reference to a limited number of embodiments and drawings, those skilled in the art will appreciate that various changes and modifications are possible from the above descriptions. For example, even if the above-described technologies are performed in a sequence differing from that of the described method, and/or components such as a system, a structure, a device, and a circuit are coupled or combined in a way differing from that of the described method or are replaced or substituted with other components or equivalents, suitable results can be achieved.

Therefore, it should be understood that other embodiments and examples and equivalents of the accompanying claims belong to the scope of the accompanying claims.

What is claimed is:

1. A method for verification of a network service in a Network Function Virtualization (NFV) environment, the method performing verification of NFV, the method comprising:
performing verification of at least one of a function, operation, and performance related to a network service; and
transmitting results of the verification to an entity related to the network service.

2. The method of claim 1, further comprising receiving a request for the verification from an NFV orchestrator of an NFV Management and Orchestration (MANO) unit,
wherein the results of the verification are transmitted to the NFV orchestrator.

3. The method of claim 2, wherein:
the request is made for each unit of verification, and the unit of verification includes at least one of a network service, a Virtual Network Function (VNF), and a VNF forwarding graph.

4. The method of claim 3, wherein, when the unit of verification is the VNF forwarding graph, the verification of the VNF forwarding graph comprises determining whether all instances of at least one VNF in the VNF forwarding graph are present.

5. The method of claim 3, wherein, when the unit of verification is the VNF forwarding graph, the verification of the VNF forwarding graph comprises determining whether the VNF forwarding graph has been generated to satisfy VNF dependency requirements.

6. The method of claim 3, wherein, when the unit of verification is the VNF forwarding graph, the verification of the VNF forwarding graph comprises checking whether an error is present in a network of the VNF forwarding graph.

7. The method of claim 6, wherein the verification of the VNF forwarding graph is performed when a forwarding path of at least one VNF in the VNF forwarding graph is generated using information about a physical location where the at least one VNF is actually present.

8. The method of claim 1, further comprising receiving a call for the verification from an application that is to request execution of the network service before execution of the network service is requested,
wherein the results of the verification are transmitted to the application.

9. The method of claim 1, wherein the verification is performed by a verification module of a NFV functional block.

10. The method of claim 1, wherein the entity related to the network service is an application, the method further comprising receiving information required for verification, provided by an NFV orchestrator, from the application.

11. The method of claim 10, wherein the information required for verification includes information about VNF catalogs and records.

12. The method of claim 10, wherein the information required for verification includes VNF information about a VNF required for the network service.

13. The method of claim 10, wherein the information required for verification includes information about resources requested to be allocated for the network service.

14. The method of claim 1, wherein performing the verification comprises:
selecting a mode of the verification;
acquiring information required for verification; and
inspecting the network service using the acquired information.

15. The method of claim 14, wherein the information required for verification includes information about VNF catalogs and records, and the VNF catalog and record information is acquired from an NFV orchestrator of an NFV MANO unit.

16. The method of claim 14, wherein the information required for verification includes VNF information about a VNF required for the network service, and the VNF information is acquired from a VNF manager.

17. The method of claim 14, wherein inspecting the network service comprises:
generating information represented in a modeling language by converting the information required for verification into information in the modeling language;
generating a state transition graph using the information represented in the modeling language; and
performing the verification by determining whether an error is present in the state transition graph.

18. The method of claim 17, wherein the modeling language is a packet-based Algebra of Communicating Shared Resources (pACSR) modeling language.

19. A method for verification of a network service in a Network Function Virtualization (NFV) environment, comprising:
receiving a request to execute a network service from an application;
transmitting a call for verification related to the network service to a verification module before executing the network service;
receiving results of the verification related to the network service from the verification module; and
checking whether a fault is present in at least one of a function, operation, and performance of the network service, using the results of the verification.

20. An apparatus for verification, the apparatus performing verification of NFV, comprising:
memory for storing at least one program; and
a processor for executing the at least one program,
wherein the at least one program comprises a verification module, and
wherein the verification module performs verification of at least one of a function, operation, and performance related to the network service, and transmits results of the verification to an entity related to the network service.
